(19) United States
(12) Patent Application Publication
(10) Pub. No.: US 2008/0299522 A1
(43) Pub. Date: Dec. 4, 2008

(54) Visual Learning Tool

(76) Inventor: Kim Weber, Colgate, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/128,778

(22) Filed: May 29, 2008

Related U.S. Application Data
(60) Provisional application No. 60/941,002, filed on May 31, 2007.

(51) Int. Cl. G09B 19/22

(52) U.S. Cl. 434/128

(57) ABSTRACT

A visual learning tool comprised of: a plurality of conceptual pieces, each having a graphical learning concept representation disposed thereon; a grid having at least one slot and a plurality of apertures, the slot allowing a child to interactively place the conceptual pieces within the grid to reinforce learning of skills and concepts.

### CLAIM OF PRIORITY

This application claims priority to Provisional Application No. 60/941002, filed May 31, 2007.

### FIELD OF INVENTION

This invention relates generally to the field of visual learning tools, and in particular to a game in which graphical learning concept components are inserted into a unique grid to educate the user

### BRIEF DESCRIPTION OF THE DRAWINGS

FIG. 1 shows a top perspective view of a visual learning tool in use.

FIG. 2 shows a front view of an alternate embodiment of a visual learning device further including audio and visual cuing devices (lights and a speaker).

FIG. 3 shows a front perspective view of several alternate embodiments of graphical pieces to be inserted in the grid component of the visual learning tools.

FIG. 4 shows a front view of several alternate embodiments of conceptual pieces.

### BACKGROUND

The general trend in children's is computerized video games. However, children experience developmental stages during which it is desirable to for a child to have tactile and visual experiences, as well as social interaction beyond what a computer interface can provide.

Human interaction, as opposed to computer games, facilitates and accelerates the development of cognitive, language and motor skills for many children. Additionally, it is desirable to have such interaction for providing reinforcement and building social skills while reinforcing learning skills.

Additionally, some children find writing tedious and are intimidated by being required to articulate answers. Repetition can be an important component of learning, and teachers and parents continually strive for alternate ways to motivate children and reinforce learning skills and concepts.

It is desirable for teachers to have a novel, interactive device to engage and motivate children in performing repetitive learning tasks, and other skills that may be reinforced by physical manipulation of objects.

It is desirable to have a versatile learning tool or game that provides visual and tactile stimulation and allows a child to interact and be physically engaged were learning concepts, as well as social interaction at a level which is not possible through reliance on a computer interface. In particular, teachers and parents can can utilize a devices which allow them to positively interact with a child while teaching or reinforcing such skills.

### SUMMARY OF INVENTION

The present invention is a single or multi-player interactive device, which may be used as a learning tool for children. It allows a user to perform a physical task (inserting a . At first glance, the device resembles a component used in a commercially available game configuration known in the art, called “Connect Four,” by Hasbro, Inc. However, the structural component described herein is used in a very different manner, and has distinct structural features to accommodate a wide range rage of use by various age groups, and to incorporate versatile learning components to reinforce a variety of skills, provide visual and tactile variation and also to accommodate various learning and conceptual games using the structure.

The Hasbro, Inc. “Connect Four” game incorporates a plastic grid-like structure into which uniformly sized objects two colors can be inserted. Connect Four is a two-player board game in which the players take turns in dropping discs into a vertical grid with the objective of getting four (4) of one's own discs in a line to form visual patterns. The visual patterns are not conceptually associated with letters, colors, numbers or other concepts which must be learned by children.

The Connect Four game entails a limited use specified by the game rules setting up a plastic grid, seven and one half inches by ten inches (7½″×10″), and two (2) opposing players dropping either red or black checker chips into slots, one at a time, with each attempting to be the first to connect four (4) chips in a row of her respective color.

It has been observed that young children, who do not play Connect Four enjoy dropping pieces in the grid, and enjoy the visual and tactile stimulation from doing.

### SUMMARY OF INVENTION

The present invention uses a grid structure into which pieces of various shapes and sizes can be physically inserted and displayed. This grid structure is a component in a system which includes numerous conceptual pieces have associated with specific learning concepts, which may be of varying shapes and textures.

The system and method herein are designed to provide a tactile and visually stimulating method for a child to physically drop an object in the grid, such object being associated with a concepts (e.g., a series of numbers, letters, images) and conceptual pieces. Physical interaction and engagement facilitate and reinforce the learning process, in particular those concepts which are learned through repetition.

The act of dropping the conceptual piece into the grid structure provides a interactive reinforcement mechanism for the child. This learning device can educate a child in learning motor skills or concepts included but not limited to colors, letters, numbers, vocabulary, spelling, grammatical rules, mathematics or any other skill in which children are commonly educated.

The grid and conceptual piece components herein may be from wood, plastic, foam, edible material, clay, metal or any other material capable of handling and manipulation by children. All parts may be constructed of a material, size and shape that are safe for use by toddlers and pre-school children, or of sizes and materials appropriate for older children or adults

As defined herein, “graphical learning concept representation” refers to any representation disposed on a player piece, including but not limited to colors, numbers, letters, and other symbols related to a learning, mathematical or linguistic concepts. The graphical representation can be disposed on the player piece by any means, whether temporary or permanent, including but not limited to stickers, painting, etching, and printing.

As used herein, “conceptual piece” or “conceptual pieces” refers to any piece or component (such as a disk, block small disk counter that can be inserted into the grid in the instant invention to communicate information to the user. The player piece can be made of any shape, including circular (disk-shaped), and can be of any material including wood, foam, recyclable materials, stone, glass, metal, or plastic.

As used herein, the term “curriculum goal” refers to any concept, goal, cognitive or motor skill which is identified in a school curriculum, special education curriculum, reading or math skill, or a therapeutic therapy goal.

### DETAILED DESCRIPTION OF EMBODIMENTS

For the purpose of promoting an understanding of the present invention, references are made in the text hereof to embodiments of a visual learning tool apparatus and system, only some of which are depicted in the figures. It should nevertheless be understood that no limitations on the scope of the invention are thereby intended. One of ordinary skill in the art will readily appreciate that modifications such as the size and shape of the components, positioning of the components relative to one another, materials from which the apparatus is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure, or manner.

It should be understood that all of the drawings are not necessarily to scale, emphasis instead being placed upon illustrating the principles of the invention. In addition, in the embodiments depicted herein, like reference numerals refer to identical or nearly identical elements in the various drawings.

Moreover, the term “substantially” or “approximately” as used herein may be applied to modify any quantitative representation that could permissibly vary without resulting in a change in the basic function to which it is related. For example, one embodiment of a visual learning device is disclosed herein as being vertical. The visual learning device for children might permissibly be somewhat angled, flat, or designed in a shape other than a square or rectangle. and still be within the scope of the invention if its functionality is not materially altered.

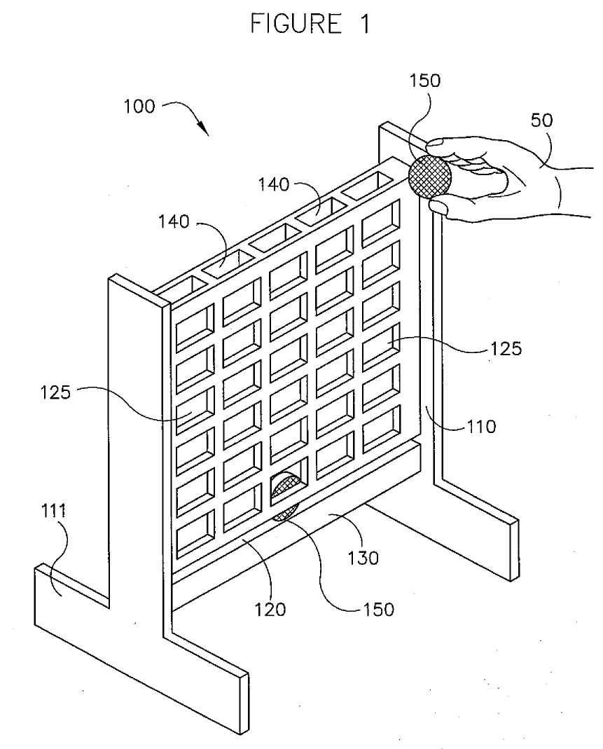

Referring now to the drawings, FIG. 1 shows a top perspective view of one embodiment of visual learning device 100 in use by player 50. Visual learning device 100 is comprised of grid 120, supports 110, 111 capture mechanism 130, slots 140, and conceptual pieces 150.

Grid 120 comprises apertures 125, which allows conceptual pieces 150 to be viewed once inserted into slot 140. In the embodiment of visual learning tool 100 shown in FIG. 1, grid 120 has a pattern of six (6) by five (5) apertures 125. However, it should be understood that any pattern can be used. Moreover, in the embodiment of visual learning tool 100 shown, grid 120 has apertures 125 on both the front face (visible from this perspective) as well as on the rear face (not visible), which allows conceptual pieces 150 to be viewed from both sides. However, it should be understood that grid 120 can alternately include apertures 125 only on the front face. In the embodiment shown, grid 120 is made of plastic, but can be made of wood, metal, stone, or any other sufficiently durable material, including combinations thereof. In the embodiment shown, apertures 125 are rectangular shaped, but in other embodiments may be circular, square or elliptical. Additionally, apertures need not be uniform in shape or size.

In the embodiment shown, apertures 125 are sized such that a single player piece 150 is visible through each aperture 125. In the embodiment of visual learning device 100 shown in FIG. 1, apertures 125 are square shaped. It should be understood, however, that any shape aperture 125 can be employed. Additionally, in other embodiments, grid 120 may have fewer or more sides, and may have sides which are solid in combination with sides having apertures.

Conceptual pieces 150 are inserted into slot 140 at the top of grid 120, pass through grid 120, and are supported by capture mechanism 130. Capture mechanism 130 is a rotatable bar across the bottom of grid 120 such that when in the position shown in FIG. 1, keeps conceptual pieces 150 positioned within grid 120, but when pivoted either forward or backward, allows conceptual pieces 150 to pass through grid 120 and below Visual learning device 100.

In the embodiment shown, supports 110, 111 allow grid 120 to be positioned substantially vertically. Supports 110, 111 are positioned at the sides of grid 120 and are secured to grid 120 by any mechanism known and used in the art. However, in alternate embodiments of Visual learning device 100, grid 120 and supports 110, 111 are formed of one integral piece. Furthermore, alternate numbers of supports 110, 111 can be used, including one (1) or greater than two (2). Supports 110, 111 are, in the embodiment shown, also made of plastic, but can alternately be made of any sufficiently strong material, including wood, foam, recyclable materials, metal, stone, or combinations thereof. In other embodiments, supports 110 and 111 may consist of separate components (such as a stand or bracket) or may be omitted entirely.

It should also be understood that Visual learning device 100 can be constructed without the use of supports 110, 111. In such an embodiment, grid 120 is not positioned vertically, but rather laid flat. In such an embodiment, grid 120 only needs apertures 125 on the front face.

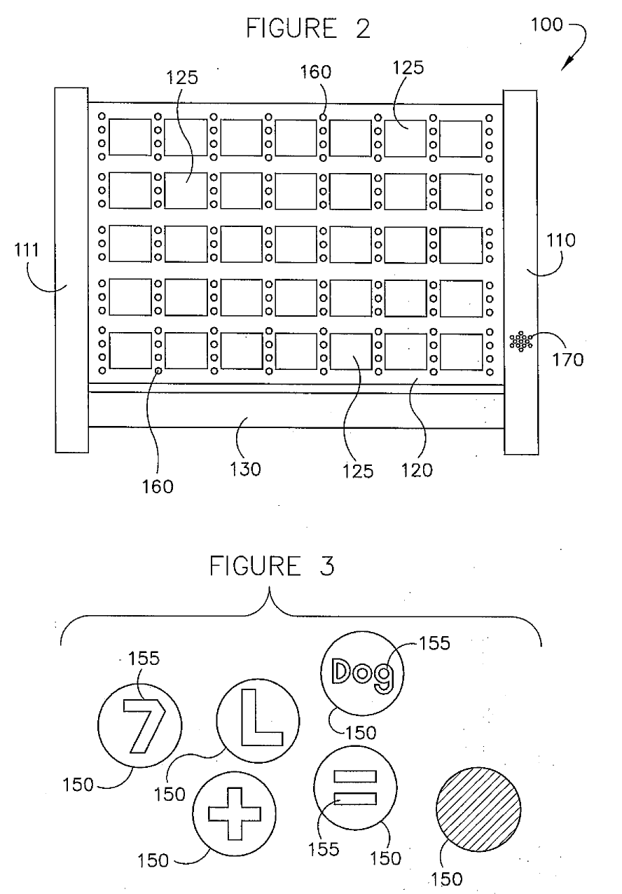

FIG. 2 shows a front view of an alternate embodiment of visual learning tool 100 in which visual learning device 100 further includes a visual or audio cuing device such as lights 160 and speaker 170. In this embodiment, lights 160 can be of any color and add to the visual characteristics of using Visual learning device 100. For example, when used to teach an young child motor skills, lights 160 can be used to indicate which column the conceptual pieces (not shown) should be placed. In the embodiment shown in FIG. 2, lights 160 are positioned vertically between the columns. However, it should be understood that lights 160 can instead be positioned between the horizontal rows, can be positioned both vertically and horizontally, or in any other configuration, and can also be positioned on supports 110, 111. Furthermore, lights 160 can be programmed to teach sequencing to the user or can flash to indicate proper use of visual learning tool 100 or to add to the aesthetic appearance. In the embodiment shown, lights 160 are LEDs (light emitting diodes), but can be any type of light commonly known and used in the art. Additionally, conceptual pieces 150 may omit sounds or may include lights (not shown)

Also visible in the embodiment of Visual learning device 100 shown in FIG. 2 is speaker 170. Speaker 170 can provide audio cues while visual learning tool 100 is in use or can be used to indicate proper use of visual learning tool 100, alone or in combination with lights 160. In addition, the embodiment of visual learning tool 100 shown in FIG. 2 includes both lights 160 and speaker 170. It should be understood that alternate embodiments of Visual learning device 100 can include only one (1) of lights 160 and speaker 170 or additional features. Furthermore, embodiments of visual learning tool 100 including lights 160 and/or speaker 170 would also require a power source (not shown). The power source could be a connection to an electrical outlet or a battery sufficient to operate the lights 160 and/or speaker 170.

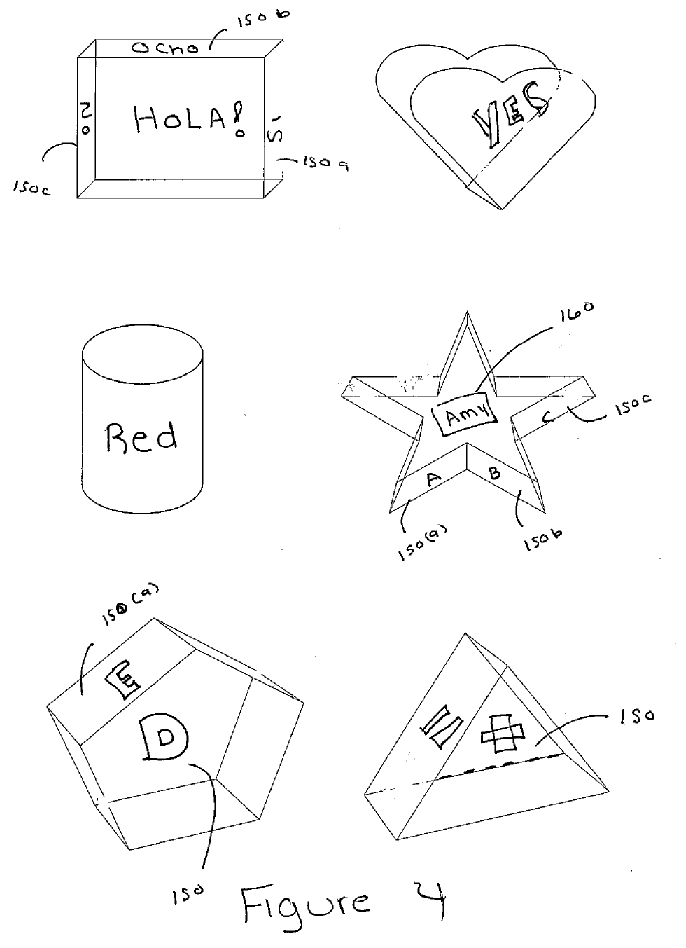

FIG. 3 shows a front view of several alternate embodiments of conceptual pieces 150 in a disk shape. As provided supra, visual learning tool (not shown) is intended to educate a child (not shown), whether infants learning motor skills, toddlers learning colors, letters, and numbers or a related age appropriate concept, or older children learning vocabulary, reading, spelling, math or any other concept taught or skill reinforced in a grade school setting. As such, conceptual pieces 150 can include various graphical learning concept representations 155 or other identifying markings. For example, graphical learning concept representation 155 can be numbers, letters, words, symbols (a plus (+) sign or equals (=) sign), or a color, depending on what it is intended to be taught to the user. Graphical learning concept representation 155 can be affixed to conceptual pieces 150 by any means commonly known and used in the art, including but not limited to printing, stickers, painting, etching, and combinations thereof. Furthermore, graphical learning concept representation 155 can be positioned on only one (1) side of conceptual pieces 150 or on both sides, and graphical concept representation 155 can be the same on both sides or different on each side. In the embodiment shown, conceptual pieces 150 are made of plastic, but can alternately be made of any material commonly used in the art, including wood, foam, recyclable materials, metal, stone, and combinations thereof.

FIG. 4 shows a front view of several alternate embodiments of conceptual pieces 150 in a disk shape having multiple surfaces (150a,150b,150c) for graphical learning concept representation. It should be noted that conceptual pieces 150 may be a varying shapes and sizes and a single embodiment of visual learning device 100 may include conceptual pieces 150 of varying shapes and sizes. Additionally, in some embodiments, conceptual pieces 150 may include removable or personalized indicia, such as sticker 160 which may be applied to conceptual pieces 150.

While the visual learning tool has been shown and described with respect to several embodiments in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A visual learning device comprised of:
a plurality of conceptual pieces;
a grid, said grid having at least one slot and a plurality of apertures, said at least one slot allowing each of said plurality of conceptual pieces to be inserted within said grid, and said plurality of apertures allowing one of said plurality of conceptual pieces to be viewed when positioned within said grid;
a capture mechanism, said capture mechanism temporarily keeping said at least one player piece within said grid; and
wherein each of said plurality of conceptual pieces has a graphical learning concept representation disposed thereon.

2. The device of claim 1, wherein said device further includes at least one support, said at least one support supporting said grid in a substantially vertical orientation.

3. The device of claim 1, wherein said device further includes at least one reinforcement device selected from a group consisting of a light, a speaker, a bell, a buzzer and a dispenser.

4. The device of claim 1, wherein each of said plurality of conceptual pieces has more than one surface each being capable of displaying a said graphical learning concept representation thereon, such that a different said graphical learning concept representation may be visible in said grip depending on the position in which each of said plurality of conceptual pieces is placed.

5. The device of claim 1, wherein said grid has at least one surface selected from a group consisting of a front surface, a back surface and at least one side surface, each of said more than one surfaces having apertures through which conceptual pieces are visible.

6. The device of claim 1, wherein each of said plurality of conceptual pieces, said grid, and said capture mechanism are made of a material selected from a group comprised of plastic, wood, metal, stone, foam, recyclable materials and combinations thereof.

7. The device of claim 1, wherein said graphical learning concept representation is selected from a group consisting of a number, a letter, a word, a symbol, a vocabulary term, a foreign word, a concept from a list to be memorized, a vocabulary term, a verbal concept, a mathematical concept, and a color.

8. An education game comprised of:
a plurality of conceptual pieces, each of said plurality of conceptual pieces having a graphical learning concept representation disposed thereon;
a grid, said grid having at least one slot and a plurality of apertures, said at least one slot allowing each of said plurality of conceptual pieces to be inserted within said grid, and said plurality of apertures allowing one of said plurality of conceptual pieces to be viewed when positioned within said grid;
at least one support, said at least one support supporting said grid in a substantially vertical orientation; and
a capture mechanism, said capture mechanism temporarily keeping said at least one player piece within said grid;
wherein said plurality of conceptual pieces are adapted to educate a user of said game.

9. The game of claim 8, wherein said game further includes at least one reinforcement component selected from a group consisting of a light, a speaker, a removable indicia, a magnet and a sticker.

10. The game of claim 8, wherein said grid has a front surface and a back surface, said plurality of apertures positioned only on said front surface or on both said front surface and said back surface.

11. The game of claim 8, wherein each of said plurality of conceptual pieces, said grid, said at least one support, and said capture mechanism are made of a material selected from a group comprised of plastic, wood, metal, stone, foam, recyclable materials and combinations thereof.

12. The game of claim 8, wherein said graphical learning concept representation is selected from a group comprised of a number, a letter, a word, a symbol, and a color.

13. The game of claim 8, wherein each of said plurality of conceptual pieces has more than one surface each being capable of displaying a said graphical learning concept representation thereon, such that a different said graphical learning concept representation may be visible in said grip depending on the position in which each of said plurality of conceptual pieces is placed.

14. A child's educational system comprised of:
a plurality of conceptual pieces, each of said plurality of conceptual pieces having a graphical learning concept representation disposed thereon, said representation adapted to educate a child using said educational device;
a grid, said grid having at least one slot and a plurality of apertures, said at least one slot allowing each of said plurality of conceptual pieces to be inserted within said grid, and said plurality of apertures allowing one of said plurality of conceptual pieces to be viewed when positioned within said grid;
at least one support, said at least one support supporting said grid in a substantially vertical orientation;
a capture mechanism, said capture mechanism temporarily keeping said at least one player piece within said grid; and
a curriculum goal selected from a group consisting of a reading skill, a reading skill, a mathematical skill, an academic concept, a therapeutic goal, a motor skill, an associative skill and an interactive skill.

15. The educational device of claim 14, wherein said educational device is further adapted to be electrically connected to a power source.

16. The educational device of claim 14, wherein each of said at least one light is selected from a group comprised of a light emitting diode.

17. The educational device of claim 14, wherein said grid has a front surface and a back surface, said plurality of apertures positioned only on said front surface or on both said front surface and said back surface.

18. The educational device of claim 14, wherein each of said plurality of conceptual pieces, said grid, said at least one support, and said capture mechanism are made of a material selected from a group comprised of plastic, wood, foam, recyclable materials, metal, stone, and combinations thereof.

19. The educational device of claim 14, wherein said graphical learning concept representation is selected from a group comprised of a number, a letter, a word, a symbol, and a color.
